(19) United States
(12) Patent Application Publication
(10) Pub. No.: US 2020/0037595 A1
(43) Pub. Date: Feb. 6, 2020

(54) INSECT LURE DEVICE AND METHOD FOR MAKING AN INSECT TRAP

(71) Applicant: Tanada Corporation d/b/a Farma Tech International Corporation, North Bend, WA (US)

(72) Inventor: Peter Cook, North Bend, WA (US)

(73) Assignee: Tanada Corporation d/b/a Farma Tech International Corporation, North Bend, WA (US)

(21) Appl. No.: 16/532,214

(22) Filed: Aug. 5, 2019

Related U.S. Application Data
(60) Provisional application No. 62/715,156, filed on Aug. 6, 2018.

(51) Int. Cl. A01M 1/02; A01M 1/14; A01M 1/20

(52) U.S. Cl. CPC A01M 1/02; A01M 1/2005; A01M 1/14

(57) ABSTRACT

An insect trap comprising a trap shell having a first open end opposite a second open end and defining a trap interior having a triangular prism shape; a hanger for suspending the trap shell from an object, wherein a portion of the hanger extends into the trap interior; and an insect lure device suspended within the trap interior, the insect lure device comprising a lure wafer and a flexible container enclosing the lure wafer, wherein the lure wafer comprises an insect attractant chemical incorporated in a solid substrate such that, in a first stage, the insect attractant chemical controllably evaporates to a gaseous state into the flexible container, and wherein the flexible container is gas-permeable such that, in a second stage, the insect attractant chemical in the gaseous state passes through the flexible container into the trap interior.

### CROSS-REFERENCE TO RELATED APPLICATION(S)

This application is a Non-provisional patent application of U.S. provisional patent application No. 62/715,156, filed Aug. 6, 2018. This application is incorporated by reference herein in its entirety and for any purposes.

### TECHNICAL FIELD

The present disclosure relates generally to an insect trap and a method for assembling the trap, and more specifically to an insect trap having a lure device with improved evaporation rate.

### BACKGROUND

Insect traps, such as a Jackson-style trap used for fruit fly survey and detection, may require baiting the trap through placement of chemical lures within the trap interior to attract the target insect. For example, the conventional Jackson-style trap requires the technician to install the lure by either dipping a wick into the chemical (in liquid form) and then installing the chemical-infused wick into the trap interior, or by packing the chemical (in gel form) into a cup and attaching the chemical-containing cup to the trap. As such, the technician must physically handle the chemical lures, which may be undesirable for the technician, and/or the chemical may accidentally drip or be deposited where unwanted, which again may be undesirable and require clean up. Furthermore, the current process of baiting a trap in the field is made more complicated and time consuming by the need to physically handle and load the chemical into the lure before the lure can be attached to the trap. In addition, existing lures may be subject to an excessive rate of evaporation of the chemical from the lure, which may necessitate more frequent replacement of the lures and/or traps. Thus, users and producers of insect lure devices and traps continue to seek improvements thereto.

### SUMMARY

An insect trap in accordance with some examples herein includes a trap shell having a first open end opposite a second open end and defining a trap interior having a triangular prism shape; a hanger for suspending the trap shell from an object, wherein a portion of the hanger extends into the trap interior; and an insect lure device suspended within the trap interior, the insect lure device including a lure wafer and a flexible container enclosing the lure wafer, wherein the lure wafer comprises an insect attractant chemical incorporated in a solid substrate such that, in a first stage, the insect attractant chemical controllably evaporates to a gaseous state into the flexible container, and wherein the flexible container is gas-permeable such that, in a second stage, the insect attractant chemical in the gaseous state passes through the flexible container into the trap interior.

In some examples, the insect lure device includes a first lure wafer with a first type of attractant chemical and a second lure wafer with a second insect attractant chemical, wherein the flexible container encloses both the first lure wafer and the second lure wafer. The insect attractant chemical may include first type of attractant chemical and the insect lure device may further include a second type of attractant chemical incorporated into the solid substrate.

In some examples, the insect lure device is suspended within the trap interior by the portion of the hanger extending into the trap interior. In some examples, the insect lure device is a first lure device, and the insect trap further includes a second insect lure device suspended in the trap interior. The second insect lure device may include a second type of attractant chemical and is enclosed in a second gas-permeable flexible container. The insect lure device may be suspended within the trap interior by the hanger with each of the first lure device and the second insect lure device hanging on opposite sides of the portion.

In some examples, the insect lure device is fixed to the trap shell. In some examples, the insect trap includes a sticky layer, positioned at a base of the trap shell, wherein the sticky layer forms a portion of the trap interior. In some examples, the insect trap includes a catch board comprising an adhesive layer positioned at a base of the trap shell, wherein the sticky layer foul's a portion of the trap interior.

An insect lure device in accordance with some examples herein may be configured to be suspended within a trap interior of an insect trap and includes a lure wafer and a flexible container enclosing the lure wafer, wherein the lure wafer includes an insect attractant chemical incorporated in a solid substrate such that, in a first stage, the insect attractant chemical controllably evaporates to a gaseous state into the flexible container, and wherein the flexible container is gas-permeable such that, in a second stage, the insect attractant chemical in the gaseous state passes through the flexible container into the trap interior. In some examples, the insect lure device includes a first lure wafer with a first type of attractant chemical and a second lure wafer with a second insect attractant chemical, wherein the flexible container encloses both the first lure wafer and the second lure wafer.

In some examples, the insect lure device includes a second insect lure device including a second lure wafer and a second flexible container, wherein the second lure wafer includes a second insect attractant chemical incorporated into a second solid substrate, such that in the first stage, the second insect attractant chemical controllably evaporates to a gaseous state into the second flexible container and wherein the second flexible container is gas-permeable such that, in the second stage, the second insect attractant chemical in the gaseous states passes through the second flexible container and into the trap interior.

In some examples, the flexible container is configured to controllably release the insect attractant chemical in the gaseous state from the flexible container into an ambient air. In some examples, the flexible container is configured to controllably release the insect attractant chemical by reducing an effect of airflow through the trap interior thereby reducing a rate of evaporation of the insect attractant chemical.

In some examples, the insect attractant chemical includes at least one of methyl eugenol, trimedlure, cuelure, raspberry ketone, or terpinyl acetate. In some examples, the insect lure device includes an insecticide.

A method of assembling an insect trap in accordance with some examples herein may include placing an edge portion of an insect lure device against a surface of a flattened insect trap shell, and folding the flattened insect trap shell along a plurality of parallel folding lines to reconfigure the flattened insect trap shell into a folded insect trap which includes a trap interior having a triangular prism shape with two opposite open ends, and wherein the folding secures the edge portion of the insect lure device between two layers of the folded insect trap allowing a remaining portion of the insect lure device to hang within the trap interior. In some examples, the edge portion is an edge portion of a container of the insect lure device, such that the folding secures a portion of the container between the two layers. In some examples, the surface of the flattened insect trap may be a first surface and the peripheral portion may be a first peripheral portion, and the method may involve, after placing the edge portion against the first peripheral portion, folding the remaining portion to a second surface opposite the first surface prior to folding the flattened insect trap shell, the folding of the flattened insect trap shell further including pressing a second peripheral portion of the second surface against the adhesive on the first surface.

The method may include forming the insect lure device by inserting a lure wafer comprising an insect attractant chemical incorporated into a solid substrate into a flexible permeable enclosure. In some examples, the permeable enclosure may be sealed along the edge portion prior to placing the edge portion against the surface of the flattened insect trap shell. The method may further include coupling a hanger to the folded trap by inserting a portion of the hanger into the trap interior. In some examples, the insect lure device may be a first insect lure device, and the method may further include coupling a second insect lure device to the folded insect trap while coupling the first insect lure device. The first and second insect lure devices may be coupled to the folded insect trap such that they are positioned to at least partially overlap each other, such that they are adjacent to each other, or such that they are spaced apart from each other or any other suitable arrangement for the particular application.

The method may include forming a plurality of weakened portions along lines of a cardboard sheet or other type of sheet stock material to define the folding lines of the flattened insect trap shell. In some examples, the method may include providing an adhesive along a peripheral portion of the surface of the flattened insect trap shell and wherein placing the edge portion of the insect lure device against the surface includes placing the edge portion against the peripheral portion. The step of providing an adhesive may involve applying a strip of two-sided adhesive to the peripheral portion or another suitable technique. In some examples, the assembled trap may be packaged, e.g. for storage and/or shipment. A method according to the present disclosure may thus further include packaging the insect trap by flattening the folded insect trap by folding a base of the folded insect trap along a guide line disposed between the parallel folding lines. In some examples, the guide line may be defined by a weakened portion of the folded insect trap arranged parallel to the parallel folding lines.

### BRIEF DESCRIPTION OF THE DRAWINGS

FIG. 1 illustrates an insect trap in accordance with some examples of the present disclosure.

FIG. 2 illustrates components of the insect trap of FIG. 1.

FIG. 3 illustrates insect lure devices in accordance with some examples herein.

FIG. 4 illustrates a stage in assembling an insect trap in accordance with examples of the present disclosure.

FIG. 5 illustrates another stage during the assembly of the insect trap of FIG. 4.

FIG. 6 illustrates a side view of the insect trap of FIG. 4 in an assembled configuration.

FIG. 7 illustrates an enlarged portion of the insect trap of FIG. 6 designated by line 7 in FIG. 6.

FIG. 8 illustrates the insect trap of FIG. 6 during a transition into a shipping configuration.

FIG. 9 illustrates the insect trap of FIG. 6 in a shipping configuration.

FIGS. 10A-E illustrates insect lure devices according to further examples of the present disclosure.

### DETAILED DESCRIPTION

Insect traps, such as fruit fly traps, may be used to control insects, such as fruit flies or other pests, within a given area, or they may be used to survey and detect, e.g. count, the presence of insects, such as fruit flies, within the given area. When an insect trap is used for survey and detection, an assembled and baited insect trap may be positioned in a particular area for a specific period of time, measured in weeks or months. For example, there may be multiple traps positioned within a square mile, each trap with a target life of 6-8 weeks. The configuration of the insect trap and the attractant used in a given scenario are customized depending on the type of insect (e.g., the type of fruit fly) that is to be surveyed and detected. For example, a trap may have an open-ended (or open flow) configuration allowing the substantially unobstructed passage of air from one end to an opposite end of the trap, or it may be substantially enclosed with a single entry point to allow the insects to enter the trap. The term attractant as used herein refers to the material (e.g., chemical compound) that is provided in the interior of the trap and used to attract or lure an insect into the insect trap. In some scenarios, pest control may additionally be of interest, in which case an insecticide (i.e. a chemical compound that may incapacitate or kill the target insect) may additionally be employed. An insect may be attracted to the trap and more specifically to the chemical vapor emanating from the trap (i.e. from the attractant). Once the insect enters the trap, the insect may be prevented from leaving the trap, such as by contacting a sticky substance positioned within the interior of the trap. In some insect control scenarios, the sole purpose of trapping insects in the trap is for counting the insects without aiming to harm the insects, although in some scenarios pest control may be a desired outcome in which case an insecticide may additionally be provided in the trap to cause the insect to eventually die.

In detection and monitoring scenarios, a technician may monitor individual traps at various intervals to identify if any insects have been trapped and/or to count the number of insects trapped within a given trap. If an insect has been caught in the trap, that insect trap may be swapped out with a new insect trap or, if the lure has an active life remaining, the adhesive material to which the insect is stuck may be replaced, and the caught insect may be evaluated for identification and reporting. If no insects are caught, after a designated period of time, the insect trap will be discarded and a new insect trap will be installed, or the insect trap may be reloaded with a fresh lure.

Referring specifically to the example of fruit fly traps, this type of trap is typically suspended on a tree. Prior to installing a fruit fly trap at a target location, a technician has to bait the trap with an insect lure. Currently known fruit fly traps, such as the Jackson style cardboard trap, employ two types of lures, one of which uses a liquid attractant chemical which is infused into a wick (e.g., by dipping the wick into a vat of the attractant chemical), and the other one of which uses a gel-based attractant which is pressed into a cup-shaped container. A typical Jackson style trap is baited by placing the insect lure, which may contain about 6 grams of the attractant chemical, within the trap. In both of the scenarios described above for baiting a trap, a technician will need to handle the attractant chemical in order to load it to the insect lure and/or place it within the trap interior. This handling of the chemical may expose the technician to physical contact with the various chemicals, and repetitive exposure may be undesirable. In addition, the process of having to load the chemical to the lure and then coupling the lure to the trap and/or assembling other components of the trap may be time consuming, which may introduce inefficiency into the process of installing traps and extend the amount of time that the technician is in proximity to the chemicals. Yet another characteristic of existing traps is that their lures may be subject to higher than desirable rates of evaporation of the attractant chemical, thus shortening the life of the trap, which can increase the cost of insect detection and monitoring (e.g., by having to replace traps more often) and again, increase exposure of the technicians to the chemicals (e.g., as the technician would have to replace traps more often). An insect lure device and a trap using a lure device according to the principles of the present invention may address one or more of the shortcomings of existing insect traps, such as the Jackson style trap.

An insect lure device according to some examples herein and which is configured to be suspended within a trap interior of an insect trap, may include a lure wafer and a flexible container enclosing the lure wafer. The lure wafer may include an insect attractant chemical, which is incorporated (e.g., impregnated, embedded, or infused) in a solid substrate such that, in a first stage of the attractant release process, the insect attractant chemical controllably evaporates from the substrate to a gaseous state within the interior of the flexible container. The flexible container may be formed of a gas-permeable material (e.g., a gas-permeable membrane) such that, in a second stage of the attractant release process, the insect attractant chemical in its gaseous state passes through the gas-permeable flexible container into the trap interior, emanating outward from the insect lure device to cause insects to be attracted to the lure device. The gas-permeable material may be selected from any suitable material, such as a mesh, web, netting, or another type of fabric made from any suitable synthetic (e.g. polymer) or natural (e.g., cotton or linen) material.

In some examples, the flexible container may be made from any suitable natural or synthetic fabric, such as fine netting fabric, tightly knit or tightly woven fabric, or from a paper or plastic (e.g., nylon) tea bag. A suitable gas-permeable material may be structured to define a network of openings through the thickness of the material of sufficiently large size to allow for a controlled or retarded release of the chemical from the surface of the wafer and through the material, but which are sufficiently small to prevent the rapid evaporation of the attractant chemical (also referred to as flash off) upon exposing the lure to ambiance.

Upon experimentation with different types of lure devices, the inventor has recognized that existing lures may suffer from excessively rapid evaporation, which may result in the lure having a life span of up to 6 weeks. The embodiments described herein may provide the unexpected result of retarding evaporation of the chemical, which can be particularly advantageous for open flow traps where the movement of air between the open ends and thus through the interior of the trap may further increase the evaporation rate by reducing the ambient pressure and/or by carrying away chemical vapors and thus reducing the concentration of the chemical within the trap, all of which may increase the evaporation rate of the attractant chemical. An insect lure device and a trap in accordance with the present disclosure may have an improved life span, for example up to 8 weeks or more, or about 30% increase or more. In some examples, the active life of the lure may be different than 30%, such as up to 25%, or up to 20%, or in some cases less than that. Surprisingly, through the experimentation, the inventor has discovered that while evaporation rate and thus the active life of a lure device can be improved in accordance with the principles of the present disclosure, the effectiveness of the lure in attracting insects is not reduced despite the use of controlled release (e.g., in two stages) of the attractant.

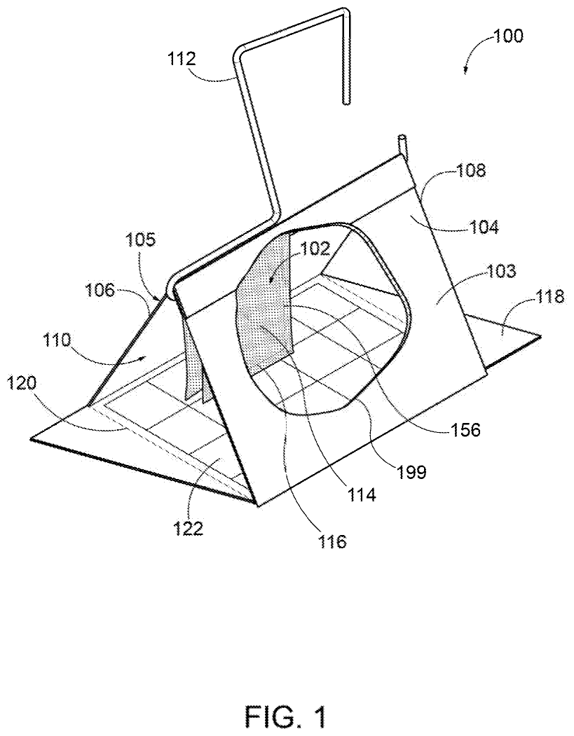

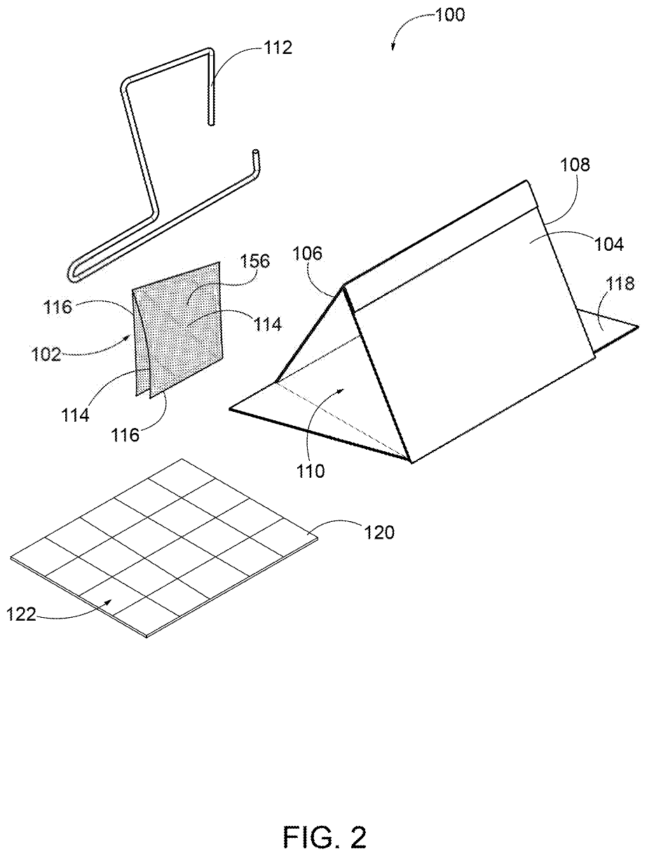

FIG. 1 illustrates an insect trap in accordance with some embodiments of the present disclosure, with a portion of the wall of the trap shell removed, as indicated by the cutout 199, to show the interior of the trap. FIG. 2 is an exploded view showing components of the insect trap 100 of FIG. 1 in a disassembled configuration. In the example in FIGS. 1 and 2, the insect trap 100 includes a trap shell 104, an insect lure device 102, and a hanger 112. The components of the trap and arrangement thereof in FIGS. 1 and 2 are illustrative only and variations, such as combining, eliminating, or adding components, are all envisioned.

The insect trap 100 in the examples in FIGS. 1 and 2 is of an open-flow configuration. By an open-flow configuration it is implied that the trap is designed such that air is permitted to flow substantially unobstructed through the trap between the opposing first and second open ends of the trap shell 104. In the example in FIGS. 1 and 2, the trap shell 104 is implemented as a hollow structure defining a trap interior 110. In this example, the trap shell 104, and thus the trap interior 110, have a substantially triangular prism shape. However, in other examples, the trap shell may have a different shape, such as a rectangular prism shape, or a substantially tubular shape. The trap shell includes first and second walls 103 and 105, respectively, joined to one another at the top portion of the trap shell 104, and a base 118 joined to and extending between the bottom edges of the walls, thus defining the bottom portion of the trap shell. The walls and base may be formed of any suitable rigid or semi-rigid material, such as cardboard, paperboard, or a rigid or semi-rigid sheet of plastic material. For example, the trap shell may be implemented using a Jackson Trap Body formed of white, bleached sulphate, solid paperboard.

The trap shell 104 may have first and second open ends, 106 and 108 respectively, opposite one another that allow air to flow substantially freely from the first open end 106 through the trap interior 110 to the second open end 108. In some examples, the first open end 106 and second open end 108 may be generally similar in shape and/or size, (e.g., for ease of manufacturing). In other examples, the two open ends 106 and 108 may be differently sized or shaped. In some embodiments, the base 118 may have substantially the same shape (e.g., a rectangular shape) and/or size as that of the walls 103 and 105. In other embodiments, the base may have a different shape. For example, the base 118 may be shaped as a parallelogram with respective portions of the base extending beyond the open sides of the trap shell. In some embodiments, the insect trap 100 may include a removable insert 120 that includes a sticky layer 122. The insert 120 may be configured to be positioned within the trap interior 110 such that it is supported by the base 118. In some embodiments, the insert 120 may be substantially coextensive with the base 118. In some embodiments, the trap 100 may not include an insert and the base 118 may instead be provided with a sticky layer 122 on the inward facing side of the base 118.

As further shown in FIGS. 1 and 2, the insect trap 100 may include a hanger 112 for suspending the trap 100 from an object, such as a tree located in a target area for monitoring. The hanger 112 may be implemented using any suitable structure which is configured to be coupled to the trap shell 104 and which is further configured to couple the trap shell 104 to another structure. For example, the hanger 112 may be made from a shaped wire which includes a portion that extends into the trap interior 110 (e.g., passing through the top portion of the trap shell) and another portion that includes a hook or other suitable structure design for hanging the hanger 112 from another structure.

In accordance with the principles of the present disclosure, the insect trap 100 may include an insect lure device 102 which is configured to provide a two-stage release of the attractant into the ambiance. When the trap 100 is in an assembled and ready to deploy configuration, such as that shown in FIG. 1, the insect lure device 102 may be coupled to (e.g., fixedly attached or hung upon) the hanger 112 (e.g., to the portion extending through the trap interior 110). In the assembled and ready to deploy configuration, the insect lure device 102 may be suspended within the trap interior 110 by the portion of the hanger 112 extending through the trap interior 110. The term fixedly attached implies that the component is coupled in a manner not intended to be removed by the user during a normal life of the insect trap. In some examples, certain components of the insect trap, e.g., the trap shell and the lure device, may be fixedly attached to one another and thus they may be packaged together, removing the need for a technician to assemble the insect lure to the trap and thus removing the need for directly handling the insect lure. In such examples, the components attached to the lure device (e.g., the trap shell) may be treated as consumables, (e.g., they may be discarded when the lure is partially or fully depleted as a result of the attractant chemical being partially or fully evaporated from the lure wafer).

An insect lure device 102 according to the present disclosure may be configured to be suspended within a trap interior of an insect trap. For example, the insect lure device 102 may be packaged in a flexible container 116, which is capable of being draped over a portion of the hanger 112, the flexibility of the container allowing the insect lure device 102 to hang substantially downward toward the base 118 of the trap shell 104. Existing lures are typically attached to the trap via substantially rigid support structures, such as via a rigid or semi-rigid support member holding the wick or via a rigid or semi-rigid cup that holds the gel-based attractant. This rigid attachment of the lure to the trap can result in the lure being positioned sub-optimally, (e.g., being inadvertently pushed and held close to a side of the trap shell), by the imperfect alignment of components, which may block the release of the chemical on one or more sides of the lure, reducing the effectiveness of the lure in dispersing or disseminating the attractant. This problem may be addressed at least in part by the flexible coupling of the lure wafer to the trap, (e.g., by virtue of the flexible container that encloses and is used to suspend the wafer into the trap).

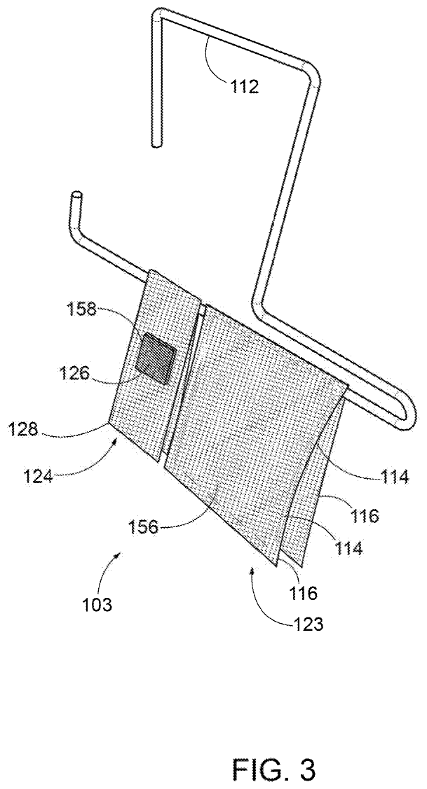

As shown in FIG. 2 and referring also to FIG. 3, an insect lure device 102 according to the present disclosure may include at least one lure wafer 114 enclosed in at least one flexible container 116. In some embodiments, the lure device 102 may include a plurality of lure wafers 114, each enclosed in at least one flexible container 116. In the embodiment of FIG. 2, the insect lure device 102 includes two lure wafers 114, defining two portions of the lure device 102, which are disposed adjacent one another when the lure device is suspended by the hanger. In the illustrated example, the lure device 102 is coupled to the hanger 102 such that each of the two portions associated with the individual wafers hangs from an opposite side of the hanger 112. In some embodiments, the two lure wafers 114 may be enclosed in two separate flexible containers 116 joined together at an adjoining edge, which may define the top edge of the lure device 102 when the lure device is suspended in the trap. In some embodiments, the individual lure wafers may be enclosed within two opposite end portions of a single flexible container 116, which by virtue of its flexibility can be draped over the hanger, as shown in FIGS. 1-3.

The lure wafer 114 includes an insect attractant chemical, which is incorporated in a solid substrate. In some examples, the incorporated insect attractant chemical is impregnated or infused into the solid substrate. Incorporating the attractant chemical into the solid substrate may involve any suitable process for injecting, embedding, impregnating or infusing a solid or semi-solid substrate made from a suitable carrier material, (e.g. a polymer), with an insect attractant chemical. Examples of the insect attractant chemical include methyl eugenol, trimedlure, cuelure, raspberry ketone, or terpinyl acetate. The different types of attractant chemical may attract different types of insects. For example, methyl eugenol may be used to attract an Oriental fruit fly, while trimedlure may be used to attract a Mediteranean fruit fly. Raspberry ketone may also be suitable attractant for certain types of fruit flies. Lure devices according to some examples herein may include a plurality of different types of attractant chemicals, which may be incorporated (e.g., by infusing multiple chemicals or a mixture of multiple chemicals) into a single wafer or by incorporating the individual attractants chemicals into respective individual wafers. The insect attractant chemical serves to attract the target insect(s) toward the lure device and thus to the interior of the trap, whereby the insect is then trapped in the trap, (e.g., by the insect becoming stuck to the sticky base). In examples according to the present disclosure, any suitable chemical that can act as an attractant to a desired target insect may be used. In some examples, the lure device may additionally include an insecticide or any suitable type of chemical that can incapacitate or kill the target insect such as to effect pest control. In some examples, insecticide may be used to incapacitate or kill the target insect(s) thereby trapping them in the trap for pest control and/or for counting purposes.

In some examples, the lure wafer 114 may be of any suitable shape and size, for example a 2 inch by 2 inch square. In other examples, the lure wafer may be of a larger size or smaller size. In some examples, the lure wafer may be one of a variety of shapes, such as a rectangle, circle, oval, polygon, triangle, or oblong shape.

As described, at least one lure wafer 114 is enclosed within a flexible container 116, which is made from a gas-permeable material (e.g., a knit or woven fabric of natural or synthetic fibers or another type of porous sheet material). The flexible container 116 is thus configured to reduce the evaporation rate and thus retard the release of the insect attractant chemical into the ambient air (e.g., on the exterior to the container 116). As such, the lure device 102 can be said to be configured for a controllable release of the chemical, also referred to herein as a two-stage release process, the first stage involving evaporation of the liquid chemical from the wafer to a gaseous chemical into the interior of the container 116, and the second stage involving the passing of the gaseous chemical through the gas-permeable container into the ambiance. By enclosing the lure wafer 114 within a container 116 made of a suitable gas-permeable material, the inventor has discovered that the active life of the lure wafer can be significantly increased without adversely affecting the ability of the lure wafer to attract insects. The active life of the lure wafer generally means the period of time during which the wafer contains and continues to release sufficient attractant to effectively attract the target insect (e.g., within an acceptable radius as defined by industry standards). The gas-permeable container 116 in effect provides a barrier to the otherwise more rapid evaporation of the attractant chemical by creating an environment within the container where the lure wafer is exposed to increased vapor pressure, thereby decreasing the evaporation rate of the chemical into the interior of the container. The permeability of the container may be tailored to control the rate of release of the attractant chemical into the ambiance. A lure device configured for a two-stage release process may be particularly advantageous for open-flow type traps, as air moving through the trap interior may further increase the evaporation rate of conventional lures. In contrast, the inventor has discovered that in a lure device 102, in which the lure wafer is enclosed in a gas permeable container as described herein, the gas permeable container acts as a wind breaker to reduce or substantially eliminate the effect of moving air on the evaporation rate of the attractant chemical. While examples herein are described as suitable for use with open-flow traps in which air may be flowing through the trap interior, it will be appreciated that lure devices of the present disclosure may be used in other traps, such as in traps in which the flow through the trap may be retarded or decreased.

The container 116 is a flexible container in that it can be easily bent, such as to allow the lure device 102 to be draped over the hanger or otherwise suspended so that it hangs freely toward the interior of the trap when the trap is in use. In some examples, the flexible container 116 may be of the size of 2.5 inch by 2.5 inch square and includes a permeable material. In some examples, the flexible container 116 may be made of polyethylene or include a polyethylene coating, which may provide the ability to seal and/or couple the container to the shell using a heat-sealing type method. In some embodiments, the flexible container 116 may include or be coated with a water-repellant or water-resistant material.

FIG. 3 shows an insect lure 103 which includes a plurality of individual lure devices 123 and 124. Any one of the lure devices 123 and 124 may be implemented using the lure device 102. While the insect lure 103 is shown as including two lure devices, the insect lure may include a different number of lure devices, for example 3, 4, or more, as may be desired for a particular application. In the example illustrated in FIG. 3, the insect lure may include a first insect lure device 123 and a second insect lure device 124, which may be suspended by the hanger 112 into the trap interior. The first and second lure devices may be arranged side by side as illustrated in FIG. 3 or they may be differently arranged, such as at least partially or fully overlapping, for example by the first lure device 124 being draped over the second lure device 123 or vice versa.

As noted, one or both of the insect lure devices 123 and 124 may be implemented using the first insect lure device 102. In some embodiments, one of the two lure devices may be different from the other in that it may include a different type of attractant chemical and/or an insecticide. For example, the second insect lure device 124 may include a second lure wafer 126 enclosed in a second flexible container 128. The second lure wafer 126 may be similar to the lure wafer 114 in that it may include a solid substrate providing the carrier material for the different type of attractant or the insecticide chemical (e.g., chemical 158). In some embodiments, the second lure wafer 126 may differ from the lure wafer 114 in shape, size, or composition. In some embodiments, the second lure wafer 126 includes a second insect attractant chemical incorporated into a second solid substrate. The second insect attractant chemical may be similar to or different than the first insect attractant chemical. The second solid substrate may be similar to or different than the first solid substrate. As described, in some examples, the second type of attractant chemical may be used to attract a second type of insect or an insect that is different or dissimilar to a first type of insect that may be attracted to the first type of attractant chemical. Similar to the first flexible container, the second flexible container 128 may be gas-permeable to enable a two-stage release process of the chemical incorporated into the second lure wafer 126.

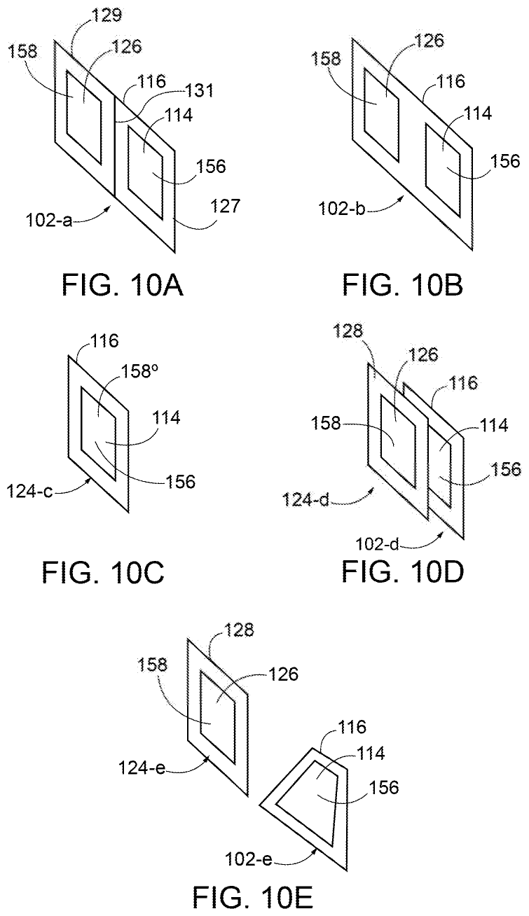

A variety of configurations of lure devices may be provided in accordance with the principles of the present disclosure. For example, and referring also to FIGS. 10A-10E, a lure device 102-a may include a first portion 127 and a second portion 129 which are joined to one another and each of which includes a respective lure wafer 114 and 126, which may include a respective attractant or pesticide chemical 156 and 158. The two lure wafers 114 and 126 are enclosed within the same gas-permeable enclosure 116, and the two individual wafers are separated by a seal 131 delineating the two portions 127 and 129. In this example, two individual or separate wafers are used and segregated into opposite end portions of the container such that a flexibility of the completed structure (of the lure device 102-a) is retained to allow the lure device 102-a to be suspended in the trap in accordance with the principles herein (e.g., by draping it over the hanger or hanging it inside the trap in some other suitable manner). In the installed configuration, the lure device 102-a may be positioned, for example when folded over the hanger, such that the two portions 127 and 129 are against one another. The lure device 102-a may be differently suspended in the trap, (e.g., by hanging it from the top of the trap along one of its peripheral edges). In some examples, the individual wafers 114 and 126 may be enclosed in respective individual flexible containers 116 and 128 as shown in FIG. 10p, to form individual lure devices 102-d and 124-d, which may then be joined to one another before installing them in the trap, or which may be individually attached to the trap shell. In yet further examples, as shown by the example lure device 102-c in FIG. 10C, a single wafer 114 may be provided with two or more different types of chemical compounds 156 and 158, which may include one or more different types of attractants and/or insecticide chemicals. In other examples, individual wafers which may carry the same or different type of a chemical compound (e.g., attractant or insecticide), may be enclosed within the same flexible enclosure, such that they are arranged side by side when the lure is hung (e.g., as shown by the example lure device 102-b in FIG. 10B) or such that the wafers at least partially overlap inside the container. In some examples, a single wafer may have distinct portions, each of which carries a different chemical compound. Wafers of other suitable shapes may be used, as shown in FIG. 10E. In further examples, individual lure devices 102-e and 124-e may be positioned when installed to the trap such that they are spaced apart, e.g., as shown in FIG. 10E. Other suitable arrangements may be used.

Referring back to FIG. 3, in use, the insect lure devices may be suspended within the trap interior 110 by the hanger 112 with each of the first lure device 102 and the second insect lure device 124 hanging in a saddle bag configuration on opposite sides of the portion of the hanger 112 which is inserted into the trap interior.

In use, in a first stage, the chemical (e.g., insect attractant chemical 156 or chemical 158) controllably evaporates (e.g. by virtue of the reduced evaporation rate of the chemical) to a gaseous state into the flexible container (e.g., container 116 or 128). At a second stage, the insect attractant chemical (e.g., chemical 156 or 158) which has evaporated into gaseous state within the interior of the flexible container (e.g., container 116 or 128) passes through the flexible container (i.e. through the gas-permeable material) and is diffused into the ambiance for attracting the target insect. As described, the inventor has discovered that the configuration of enclosing the lure wafer 114 with the flexible container 116 provides the unexpected benefit of allowing the insect attractant chemical to evaporate at a lower rate from the wafer, thus extending the life of the lure, while still effectively passing into the trap interior 110 and emanating outward without the enclosure adversely impacting the ability of the lure to effectively attract the target insect(s).

For example, the insect lure device that does not use the flexible container was shown to have a life of about 6 weeks. An insect lure device according to the present disclosure has been shown to have a life of about 8 weeks or longer, or around a 30% or greater increase in the active life of the lure, which is a significant improvement. In some examples, the active life of the lure may be improved by a different amount, which may be less than 30% over existing lures, such as up to 25%, or up to 20%, or in some cases less than that. The flexible container 116 may act as a barrier to shield the lure wafer 114 from environmental factors that may increase the evaporation rate of the attractant chemical, such as increased temperature, humidity, or airflow. In the case of the latter, increased airflow may cause a drop in the surface pressure at the surface of the wafer, which tends to increase the evaporation rate.

Similarly, in embodiments in which a second insect lure device is used, in the first stage, the second insect attractant chemical controllably evaporates to a gaseous state into or within the second flexible container 128, and in the second stage, the second insect attractant chemical in the gaseous states passes through the second flexible container 128 and into the trap interior 110, from thereon emanating out of the trap to attract the target insect.

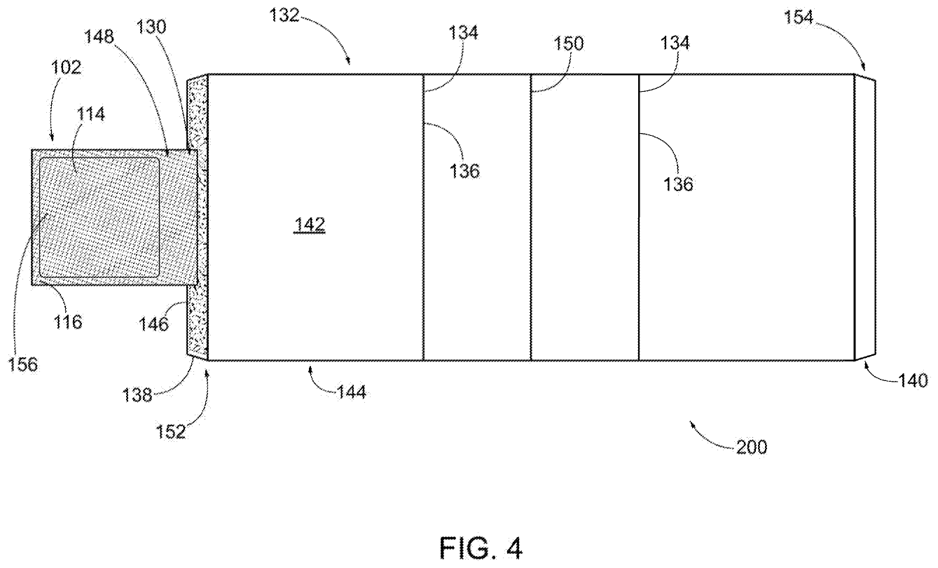

Prior to assembly of the insect lure device 102 with the trap shell, the insect lure device may be stored or shipped in a sealed bag to prevent premature evaporation of the attractant chemical. To assemble the lure device 102 for storage or shipping, the lure wafer 114 may be inserted into the flexible container 116, and the flexible container may be sealed, such as by heat sealing or by using a pressure adhesive, contact adhesive, cohesive, etc., thereby sealing the lure wafer into the flexible container. At the time of installation of the trap, the lure device may be removed from the storage or shipping bag and the lure device 102 may be loaded into the trap. In other embodiments, the lure device 102 may be permanently fixed (i.e. fixedly attached) to the trap shell, which may eliminate the need for handling of the insect lure when installing the insect trap at the location to be monitored. FIGS. 4-9 show stages of a process for assembling an insect trap 200 in accordance with further examples of the present disclosure.

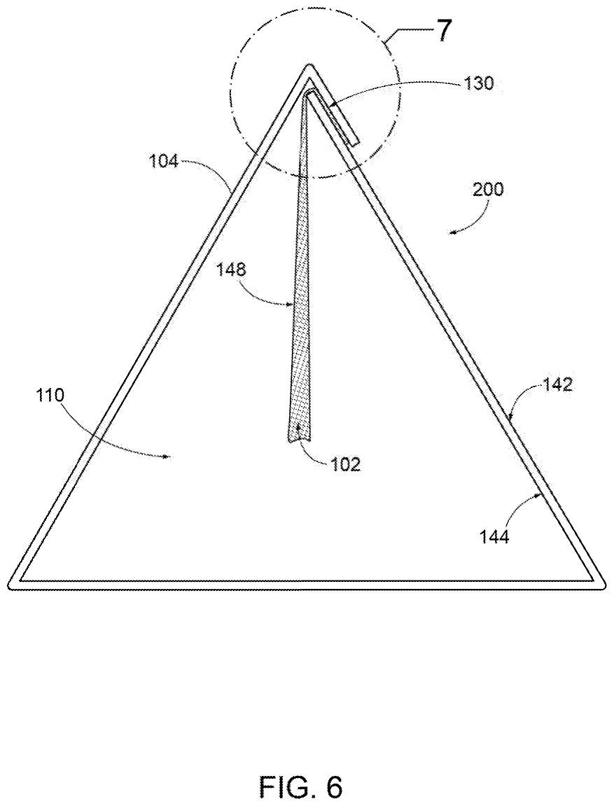

A method of assembling an insect trap in accordance with some examples herein may include placing an edge portion of an insect lure device against a surface of a flattened insect trap shell, and folding the flattened insect trap shell along a plurality of parallel folding lines to reconfigure the flattened insect trap shell into a folded insect trap which includes a trap interior having a triangular prism shape with two opposite open ends, and wherein the folding secures the edge portion of the insect lure device between two layers of the folded insect trap, allowing a remaining portion of the insect lure device to hang within the trap interior. In some examples, as shown in FIG. 4, the edge portion which is placed against the flattened insect trap is an edge portion of a container of the insect lure device, such that the folding secured a portion of the container between the two layers, as shown in FIG. 6. In some examples, the surface of the flattened insect trap may be a first surface and the peripheral portion may be a first peripheral portion, and the method may involve, after placing the edge portion against the first peripheral portion, folding the remaining portion to a second surface opposite the first surface prior to folding the flattened insect trap shell, the folding of the flattened insect trap shell further including pressing a second peripheral portion of the second surface against the adhesive on the first surface.

The method may include forming the insect lure device by inserting a lure wafer comprising an insect attractant chemical incorporated into a solid substrate into a flexible permeable enclosure (e.g., an enclosure which can be draped or folded as may be desired). In some examples, the permeable enclosure may be sealed along the edge portion prior to placing the edge portion against the surface of the flattened insect trap shell. In other examples, the permeable enclosure may not be sealed prior to attaching the lure device to the trap shell, but may instead be sealed by virtue of attaching the lure device to the trap shell (e.g., by a portion of it being placed between layers of the shell and folded to prevent removal of the lure wafer). That is, in some embodiments, the folding of the flattened insect trap shell may seal the permeable enclosure to prevent removal of the lure wafer from the permeable enclosure during normal use of the trap. The method may further include coupling a hanger to the folded trap by inserting a portion of the hanger into the trap interior. In some examples, the insect lure device may be a first insect lure device, and the method may further include coupling a second insect lure device to the folded insect trap while coupling the first insect lure device. As described herein, the first and second insect lure devices may be coupled to the folded insect trap such that they are positioned to at least partially overlap each other, such that they are adjacent to each other, or such that they are spaced apart from each other or any other suitable arrangement for the particular application.

The method may include forming a plurality of weakened portions along lines (e.g., parallel lines 134 as shown in FIG. 4) of a cardboard sheet or other type of sheet stock material to define the folding lines of the flattened insect trap shell, which in the example in FIG. 4 are parallel, while in other examples the folding lines may be in a different suitable arrangement. In some examples, the method may include providing an adhesive along a peripheral portion of the surface of the flattened insect trap shell and wherein placing the edge portion of the insect lure device against the surface includes placing the edge portion against the peripheral portion. The step of providing an adhesive may involve applying a strip of two-sided adhesive to the peripheral portion or another suitable technique. As described in further detail below, in some examples, the assembled trap may be packaged, e.g. for storage and/or shipment. A method according to the present disclosure may thus further include packaging the insect trap by flattening the folded insect trap by folding a base of the folded insect trap along a guide line disposed between the parallel folding lines. In some examples, the guide line may be defined by a weakened portion of the folded insect trap arranged parallel to the parallel folding lines.

Referring now to the specific examples in FIGS. 4-9, a flattened insect trap shell 132 may be a trap shell 104 in an unfolded or first configuration, as shown in FIG. 4. This unfolded or first configuration may be the configuration in which an insect trap assembler receives the insect trap shell from an insect trap shell manufacturer or provider. The unfolded configuration may be the configuration after the trap shell has been cut to the appropriate shape and size from the stock material but before any subsequent assembly has been performed (e.g., before application of the adhesive and/or folding lines). In other examples, the unfolded configuration may be the configuration of the trap after folding lines have been defined and/or an adhesive material has been added. The flattened insect trap shell 132 may be formed of a single piece or multiple joined pieces of a suitable sheet stock material such as paper board, (e.g., cardboard, milk carton board, or other semi-stiff or rigid paper or a suitable rigid or semi-rigid sheet of plastic).

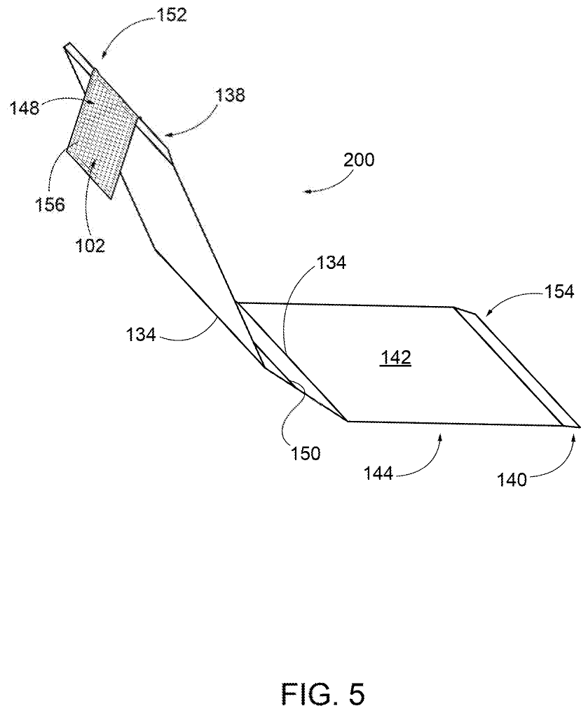

The flattened insect trap shell 132 in the example in FIGS. 4-9 includes a first surface 142 opposite a second surface 144, and a first end 152 opposite a second end 154. Both surfaces 142 and 144 are visible in FIG. 5. The first surface 142 includes a first peripheral portion 138 positioned on the first end 152. The second surface 144 includes a second peripheral portion 140 positioned on the second end 154.

The flattened insect trap shell 132 also includes a plurality of parallel folding lines 134 positioned between first end 152 and second end 154. In some examples, there are two parallel folding lines 134 in the main portion of the flattened insect trap shell 132, as shown in FIG. 4. In other examples, a different number of folding lines may be defined in the flattened insect trap shell 132 as may be appropriate to arrive at the desired folded shape (e.g., three or more parallel folding lines to arrive at a rectangular shaped prism). In some examples, the parallel folding lines 134 may be defined by weakened portions of the sheet material, such as by scored or perforated lines, living hinges or other suitable weakened portion 136 that can aid in folding the flattened insect trap shell 132 at the folding lines 134. In some examples, the weakened portion may include a material that is weaker than the surrounding material of the flattened insect trap shell 132 or may include a section where the material is the same as or similar to the surrounding material of flattened insect trap shell 132 but where the weakened portion 136 has a smaller cross-sectional thickness, thereby making it weaker than the surrounding areas.

In some examples, the flattened insect trap shell 132 also includes a guide line 150. The guide line 150 may be positioned in between the parallel folding lines 134, near a center of the flattened insect trap shell 132. The guide line 150 may also include a weakened portion such that the flattened insect trap shell 132 may be folded more easily at the location of the guide line 150.

An insect lure device 102 may be positioned adjacent to the first end 152 at the first peripheral portion 138 on the first surface 142. In some examples, the insect lure device 102 may be similar to the insect lure device 102 of FIGS. 1 and 2, with the lure wafer 114 positioned within the flexible container 116. The insect lure device 102 may include an edge portion 130 and a remaining portion 148. The edge portion 130 may be positioned adjacent to the first peripheral portion 138 of the flattened insect trap shell 132. In some examples, the flexible container 116 may be unsealed when it is positioned adjacent the first peripheral portion 138. In some examples, the flexible container 116 may be sealed at or near the edge portion 130 with the lure wafer 114 positioned within the flexible container 116 prior to positioning the edge portion 130 of the insect lure device 102 adjacent the first peripheral portion 138 of the flattened insect trap shell 132.

As further shown in the example in FIGS. 4-9, an adhesive 146 may be provided along the first peripheral portion 138. In some embodiments, the adhesive 146 is part of a piece of two-sided tape that is adhered to the first peripheral portion 138. In some examples, providing the adhesive includes applying a strip of two-sided adhesive to the first peripheral portion 138. When the flexible container 116 is positioned adjacent the first peripheral portion 138, the adhesive 146 may adhere the edge portion 130 of the flexible container 116 to the first peripheral portion 138 of the flattened insect trap shell 132.

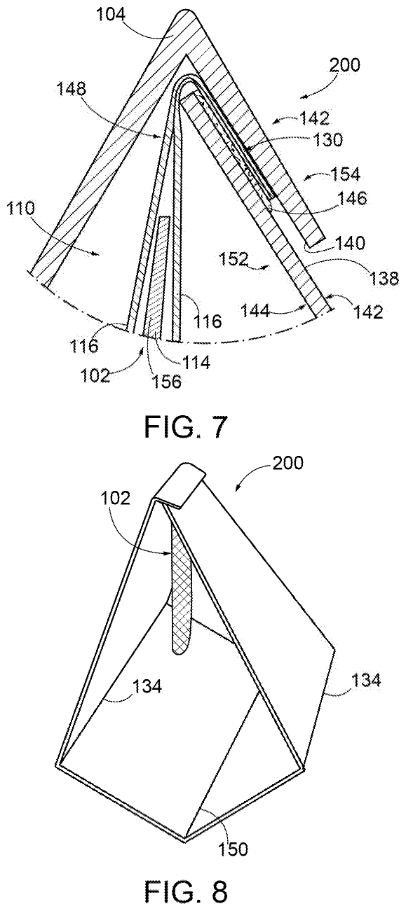

FIG. 5 shows the insect trap 200 of FIG. 4 with the flattened insect trap shell 132 provided in a semi-folded configuration. FIG. 6 shows the insect trap 200 of FIG. 4 with the flattened insect trap shell 132 folded into a folded insect trap with the trap shell 104 forming a trap interior 110 having a triangular prism shape with two opposite open ends. FIG. 7 shows an enlarged portion of the insect trap of FIG. 6. To reconfigure the flattened insect trap shell 132 into the trap shell 104 shown in FIGS. 6 and 7, the flattened insect trap shell 132 is folded along the plurality of parallel folding lines 134. After placing the edge portion 130 against the first peripheral portion 138, the flattened insect trap shell 132 may be folded so that the second surface 144 is folded in towards itself at the parallel folding lines 134, with the second end 154 positioned outside of the first end 152. The second peripheral portion 140 of the second surface 144 may then be pressed against the first peripheral portion 138 of the first surface 142, and the adhesive 146 may adhere the second peripheral portion 140 to the first peripheral portion 138 at the areas adjacent the edge portion 130 of the flexible container 116.

The folding secures the edge portion 130 between two layers (the first end 152 and the second end 154) of the trap shell 104 and allows the remaining portion 148 of the insect lure device 102 to hang within the trap interior 110. In some examples, folding the flattened insect trap shell 132 seals the flexible container 116 to prevent removal of the lure wafer 114 from the flexible container 116. In some examples, seal may mean to close, such that the permeable enclosure encloses the lure wafer within the permeable enclosure, but the permeable enclosure is still permeable.

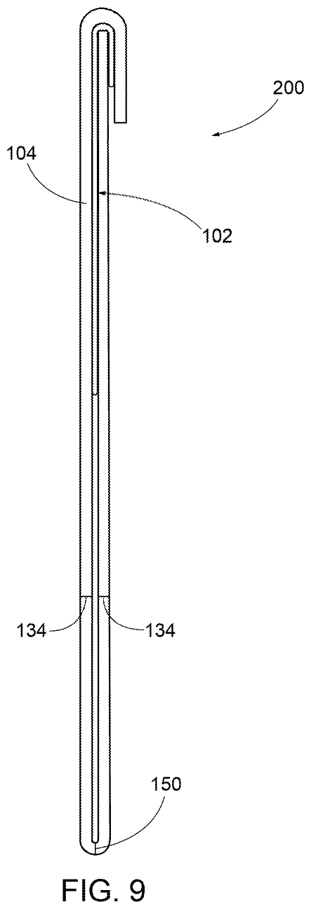

FIG. 8 shows the insect trap of FIG. 6 in a stage of transitioning the trap shell into a configuration for packaging (e.g., for storage and/or shipment). To avoid premature depletion of the chemical lure, the trap shell and lure device fixed thereto may be sealed into a non-permeable package (e.g., vacuum sealed), to reduce or prevent the evaporation of the chemical before it has been installed in the field. FIG. 9 shows the insect trap of FIG. 6 with the trap shell arranged in the packaging configuration. To transition the trap shell 104 of FIG. 7 into the packaging configuration shown in FIG. 9, a technician may lightly or gently compress the trap shell 104 and/or pull on the base of the trap shell proximate the guide line 150 so that the trap shell 104 may bend at the guide line 150. This allows the insect trap 200, with the insect lure device 102 already installed within the trap interior, to be provided in a more compact form factor (e.g., a folded flattened configuration) for storage and shipping. When ready to be installed in the field, a field technician would reconfigure the trap shell into a configuration as shown in FIG. 6, and couple a hanger, which may be packaged within the same or separate packaging, such as the hanger 112 of FIGS. 1 and 2, to the trap shell 104 by inserting a portion of the hanger into the trap interior 110. The reconfiguring of the trap shell from the configuration in FIG. 8 to that in FIG. 6 may involve simply slightly pressing or squeezing the top side and the bottom side (along the guide line 150) of the folded flattened configuration to cause it to expand to enable insertion of the hanger, neither of which steps require the technician to physically handle a chemical or the lure device.

As described herein, examples according to the present disclosure may address one or more shortcomings of existing lure devices or apparatuses for insect trapping, monitoring, and control, such as reducing or eliminating the need of a technician to physically handle attractant or pesticide chemicals or reducing his or her exposure thereto, (e.g., by decreasing the overall assembly time and steps to assemble a baited insect trap, and/or by increases the overall life of the lure device and trap). While examples are described above which may provide one or more advantages or benefits over existing devices in this field, it will be understood that in some examples, a lure device or insect trap according to the present disclosure need not provide improved performance over existing lure devices or traps.

The above-discussion is intended to be merely illustrative of the present system and should not be construed as limiting the appended claims to any particular embodiment or group of embodiments. Certain additional advantages and features of this invention may be apparent to those skilled in the art upon studying the disclosure, or may be experienced by persons employing the novel system and method of the present invention. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An insect trap comprising:
a trap shell having a first open end opposite a second open end and defining a trap interior having a substantially triangular prism shape;
a hanger coupled to the trap shell for suspending the trap shell from an object; and
an insect lure device suspended within the trap interior, the insect lure device comprising a lure wafer and a flexible container enclosing the lure wafer, wherein the lure wafer comprises an insect attractant chemical incorporated in a solid substrate such that, in a first stage, the insect attractant chemical controllably evaporates to a gaseous state into the flexible container, and wherein the flexible container is gas-permeable such that, in a second stage, the insect attractant chemical in the gaseous state passes through the flexible container into the trap interior.

2. The insect trap of claim 1, wherein the insect lure device comprises a first lure wafer with a first type of attractant chemical and a second lure wafer with a second insect attractant chemical, wherein the flexible container encloses both the first lure wafer and the second lure wafer.

3. The insect trap of claim 1, wherein the insect attractant chemical is a first type of attractant chemical and the insect lure device further comprising a second type of attractant chemical incorporated into the solid substrate.

4. The insect trap of claim 1, wherein the insect lure device is suspended within the trap interior by the portion of the hanger extending into the trap interior.

5. The insect trap of claim 1, wherein the insect lure device is a first lure device, the insect trap further comprising a second insect lure device suspended in the trap interior.

6. The insect trap of claim 5, wherein the second insect lure device comprises a second, type of attractant chemical and is enclosed in a second gas-permeable flexible container.

7. The insect trap of claim 5, wherein the insect lure device is suspended within the trap interior by the hanger with each of the first lure device and the second insect lure device hanging on opposite sides of the portion.

8. The insect trap of claim 1, wherein the insect lure device is fixed to the trap shell.

9. The insect trap of claim 1, further comprising a sticky layer, positioned at a base of the trap shell, wherein the sticky layer forms a portion of the trap interior.

10. The insect trap of claim 1, further comprising a catch board comprising an adhesive layer positioned at a base of the trap shell, wherein the sticky layer forms a portion of the trap interior.

11. An insect lure device configured to be suspended within a trap interior of an insect trap, the insect lure device comprising a lure wafer and a flexible container enclosing the lure wafer, wherein the lure wafer comprises an insect attractant chemical incorporated in a solid substrate such that, in a first stage, the insect attractant chemical controllably evaporates to a gaseous state into the flexible container, and wherein the flexible container is gas-permeable such that, in a second stage, the insect attractant chemical in the gaseous state passes through the flexible container into the trap interior.

12. The insect lure device of claim 11, wherein the insect lure device comprises a first lure wafer with a first type of attractant chemical and a second lure wafer with a second insect attractant chemical, wherein the flexible container encloses both the first lure wafer and the second lure wafer.

13. The insect lure device of claim 11, further comprising a second insect lure device comprising a second lure wafer and a second flexible container, wherein the second lure wafer comprises a second insect attractant chemical incorporated into a second solid substrate, such that in the first stage, the second insect attractant chemical controllably evaporates to a gaseous state into the second flexible container and wherein the second flexible container is gas-permeable such that, in the second stage, the second insect attractant chemical in the gaseous states passes through the second flexible container and into the trap interior.

14. The insect lure device of claim 11, wherein the flexible container is configured to controllably release the insect attractant chemical in the gaseous state from the flexible container into an ambient air.

15. The insect lure device of claim 11, wherein the flexible container is configured to controllably release the insect attractant chemical by reducing an effect of airflow through the trap interior thereby reducing a rate of evaporation of the insect attractant chemical.

16. The insect lure device of claim 11, wherein the insect attractant chemical comprises at least one of methyl eugenol, trimedlure, cuelure, raspberry ketone, or terpinyl acetate.

17. The insect lure device of claim 16, further comprising an insecticide.

18. A method of assembling an insect trap, the method comprising:
placing an edge portion of an insect lure device against a surface of a flattened insect trap shell; and
folding the flattened insect trap shell along a plurality of parallel folding lines to reconfigure the flattened insect trap shell into a folded insect trap which includes a trap interior having a triangular prism shape with two opposite open ends, and wherein the folding secures the edge portion of the insect lure device between two layers of the folded insect trap, allowing a remaining portion of the insect lure device to hang within the trap interior.

19. The method of claim 18, further comprising inserting a lure wafer comprising an insect attractant chemical incorporated into a solid substrate into a permeable enclosure to form the insect lure device.

20. The method of claim 19, further comprising sealing the permeable enclosure along the edge portion prior to placing the edge portion against the surface of the flattened insect trap shell.
